(19) United States
(12) Patent Application Publication
(10) Pub. No.: US 2009/0187280 A1
(43) Pub. Date: Jul. 23, 2009

(54) METHOD FOR CONTROLLING ICE MACHINE THROUGH TEMPERATURE SETTING

(76) Inventors: Shih-Hsien Hsu, Taipei Hsien (TW); Chun-Chuan Liu, Taipei Hsien (TW)

Correspondence Address: Joe McKinney Muncy, PO Box 1364, Fairfax, VA, 22038-1364, US

(21) Appl. No.: 12/018,052

(22) Filed: Jan. 22, 2008

(51) Int. Cl. G05B 13/00; F25C 1/00

(52) U.S. Cl. 700/275; 62/66

(57) ABSTRACT

The present invention includes steps of: setting a first temperature and a second temperature; continuously detecting the temperature inside an ice tray in an ice machine, starting an ice making schedule as the ice tray temperature is identical to or higher than the first temperature; heating the ice tray as the ice tray temperature reaches the second temperature so as to rise the ice tray temperature up to the first temperature; and repeating the steps for continuing ice making. Through the method described above, the ice machine can utilize a judgment of temperature to form an ice making schedule, which includes an ice removing procedure, a water inflow procedure and a freezing procedure, and also can utilize the detection of the temperature variation in the ice tray to judge if the water level reaches a preset position, so as to ensure a proper water amount in the ice tray.

### FIELD OF THE INVENTION

The present invention is related to an ice machine control method, and more particularly to a method for controlling the ice machine by using the temperature of the ice machine to decide the ice making schedule.

### BACKGROUND OF THE INVENTION

Ice machine is commonly used by restaurants or the general domestic refrigerators. Generally, the ice machine at least has an ice tray and a water inflow mechanism, wherein the water inflow mechanism is connected to a water source for providing water to the ice tray, then the water in the ice tray waits for being frozen, and the ice cubes are removed for repeating the ice making process. The water supplying speed of the water inflow mechanism is influenced by the pressure of the water source. If the water pressure is too low, the fixed water supplying schedule can not achieve a preset water level in the ice tray, or the water can not reach the end of the ice tray far from the water supplying mechanism, so as to cause the formed ice cubes too small or insufficient. If the water pressure is too high, the supplied water amount after the fixed water supplying schedule might exceed the normal amount, so that not only the ice becomes too big, but the components of the ice tray or the ice machine also might be damaged owing to the frozen of the overflowed water. R.O.C. Patent No. I277715, entitled “Automatic ice making device and refrigerator with thereof”, includes an ice tray and a water storage tank, and also a water pump for providing the water in the water-storage tank to the ice tray. The action of the water pump is controlled by a sensor, which is used to detect the position of the ice tray. But, this patent does not provide the method and structure for controlling water supply. Moreover, in R.O.C. Patent No. I274133, entitled “Refrigerator”, the water inflow mechanism controls the working time of a water pump for altering the water amount, so that there is no mechanism for detecting the water level, and if the pressure of the water source is unstable, then the water level in the ice tray might not be controlled accurately. Therefore, this patent can not judge that if the preset water level of the ice tray is reached or not. Furthermore, in R.O.C Patent Publication No. 330978, entitled “Automatic ice making device and freezer”, each action of the ice making device is set to execute in a fixed preset time interval, so that the action time of the ice making device can not be automatically adjusted according to the air temperature, water temperature or water amount and has to be adjusted manually.

### SUMMARY OF THE INVENTION

Consequently, owing to the defects described above, the object of the present invention is to provide an ice machine control method in which the temperature variation is utilized to judge the water level and to produce the ice making schedule.

The present invention provides a method for controlling ice machine through temperature setting. The method including steps of: setting a first temperature and a second temperature; continuously detecting the temperature inside the ice tray in the ice machine, starting an ice making schedule as the ice tray temperature is identical to or higher than the first temperature; heating the ice tray as the ice tray temperature reaches the second temperature so as to rise the ice tray temperature up to the first temperature; and repeating the steps for continuing ice making. Through the method described above, the ice machine can utilize a judgment of temperature to form an ice making schedule, which includes an ice removing procedure, a water inflow procedure and a freezing procedure, and also can utilize the detection of the temperature variation in the ice tray to judge if the water level reaches a preset position, so as to ensure a proper water amount in the ice tray.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a flow chart showing the steps of the present invention;

FIG. 2 is a flow chart showing the detailed steps of the present invention;

FIG. 3 is a three-dimensional drawing showing the structure of ice machine according to the present invention;

FIG. 4 is a sectional view showing the ice machine of the present invention;

FIG. 5 is another three-dimensional drawing showing the structure of ice machine according to the present invention; and

FIG. 6 is a schematic view showing that the temperature detecting unit detects water level.

### DESCRIPTION OF THE PREFERRED EMBODIMENT

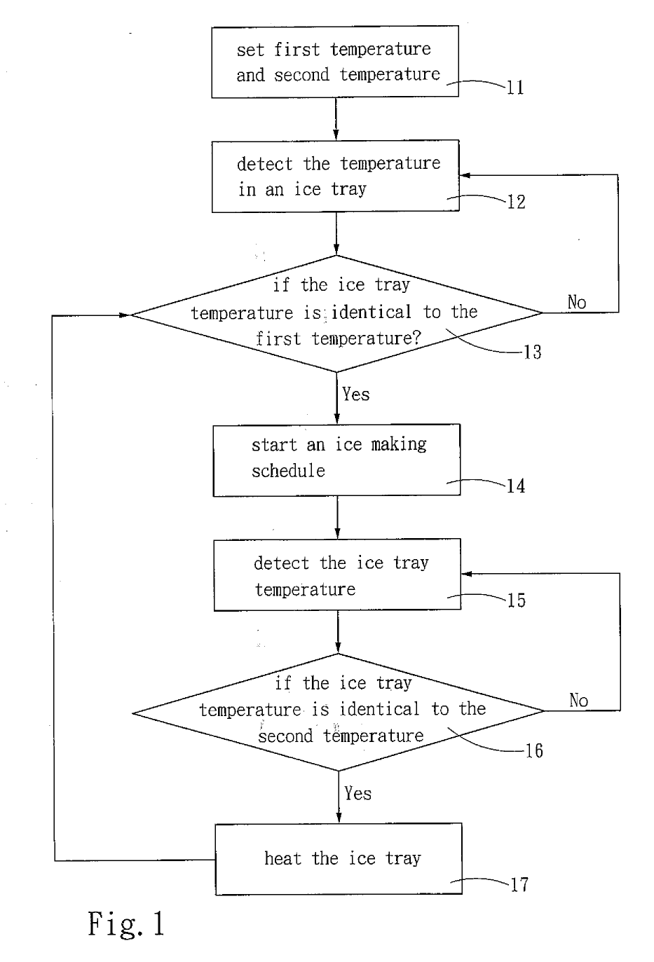

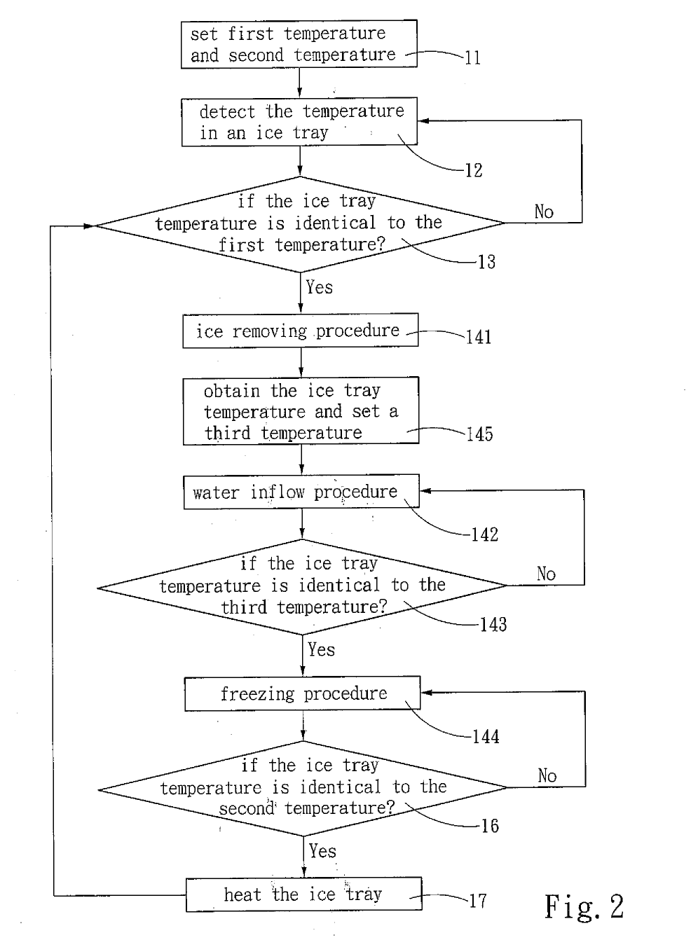

The present invention is related to a method for controlling ice machine by using temperature setting. The control method includes steps of: A. setting a first temperature and a second temperature; B. continuously detecting the temperature inside the ice tray in the ice machine; C. starting an ice making schedule as the ice tray temperature is identical to the first temperature and continuously detecting the ice tray temperature; and D. heating the ice tray as the ice tray temperature reaches the second temperature so as to rise the ice tray temperature up to the first temperature, and repeating steps B to D for continuing ice making. Please refer FIG. 1, which is a flow chart showing the control method of the present invention. First, a first temperature and a second temperature are set 11, wherein the first temperature is higher than the second temperature, the second temperature is lower than the freezing point of water, and the first temperature can be regarded as a starting temperature of ice making. Then, the temperature in the ice tray is continuously detected 12 and judged that if it is identical to the first temperature 13. If the ice tray temperature is not identical to the first temperature, then the detecting process continues 12, and if the ice tray temperature is identical to the first temperature, an ice making schedule is started 14 with the detecting process continues 15. Then, when the ice tray temperature is identical to the second temperature 16, it is decided that the water in the ice tray has frozen to become ice cubes. At this time, it starts to heat the ice tray 17 until the ice tray temperature rises up to the first temperature, so as to repeat steps of B to D for continuing the ice making procedure. In the method described above, the start and the end of the ice making schedule are decided by the detected ice tray temperature, so that the schedule can be adjusted according to the environmental temperature variation of the ice machine, wherein the ice making schedule may sequentially include an ice removing procedure, a water inflow procedure and a freezing procedure, a step of setting a third temperature, which is a water temperature different from the first temperature, can be further included between step C and step D, and the water inflow procedure can be stopped in accordance with the water level in the ice tray, which is decided by the detected ice tray temperature, so that the water amount can be controlled. Please refer to FIG. 2, which is a flow chart showing another embodiment according to the present invention. First, a first temperature and a second temperature are set 11, and the temperature in the ice tray is continuously detected 12 for obtaining the ice tray temperature to judge if the ice tray temperature is identical to the first temperature 13. When the ice tray temperature is identical to the first temperature, the ice removing procedure 141 and the water inflow procedure 142 are sequentially executed, wherein between the ice removing procedure 141 and the water inflow procedure 142, a procedure for obtaining the ice tray temperature and setting a third temperature 145 is further executed. After starting the water inflow, it will judge that if the ice tray temperature is identical to the third temperature 143, and if the ice tray temperature reaches the third temperature, it will infer that the water amount supplied to the ice tray has enough, and the water inflow procedure 142 is stopped. Then, the freezing procedure 144 continues, and the ice tray temperature is still detected for deciding if it is identical to the second temperature 16. When the ice tray temperature is identical to the second temperature, it will infer that the water in the ice tray has already frozen and becomes ice cubes. At this time, the ice tray is heated 17 for rising the temperature back to the first temperature, so as to return the process back to the ice removing procedure 141 and restart the ice making schedule. Thereby, an ice machine control method which adjusts the ice making schedule and the water inflow of the ice tray both according to temperature variation can be achieved.

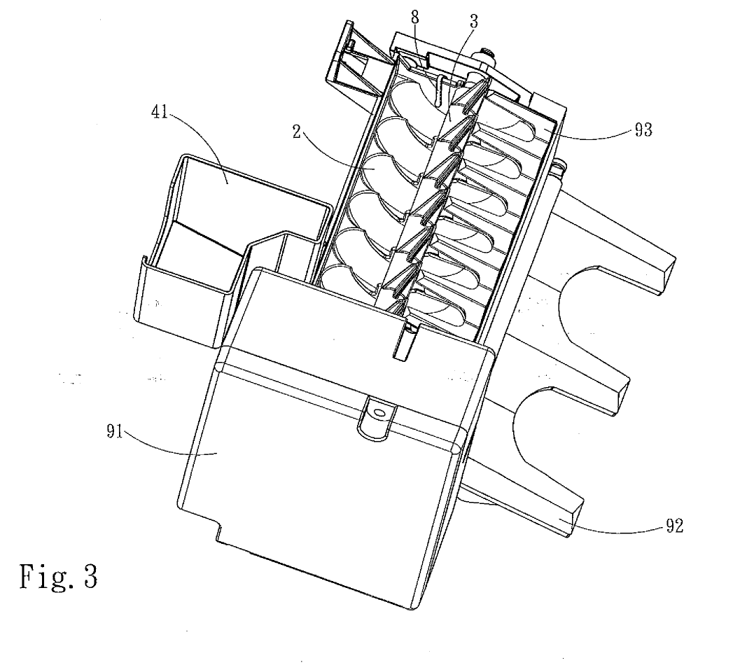

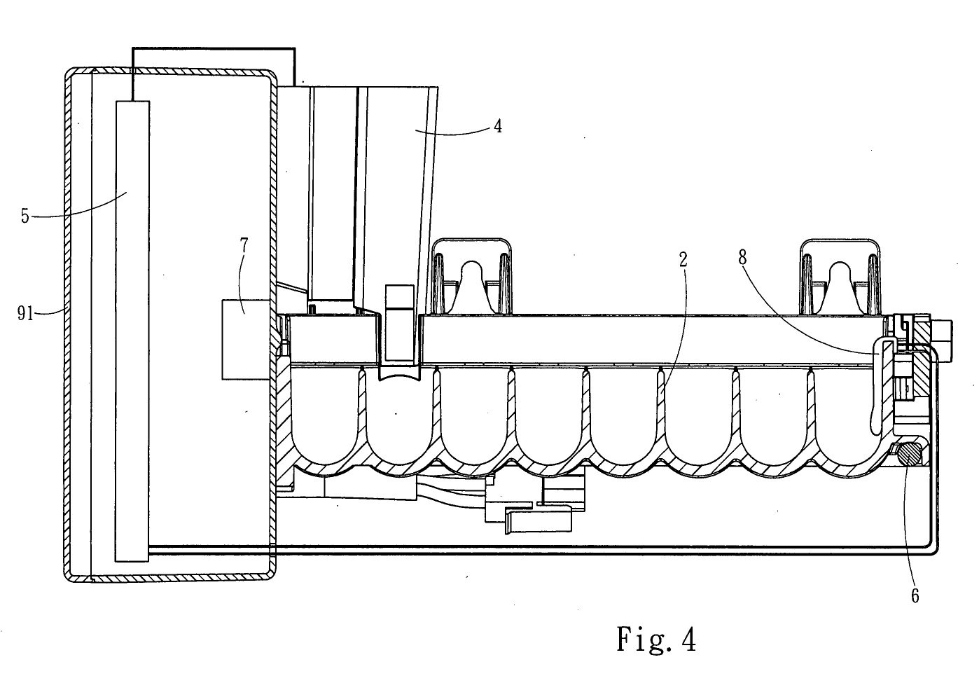

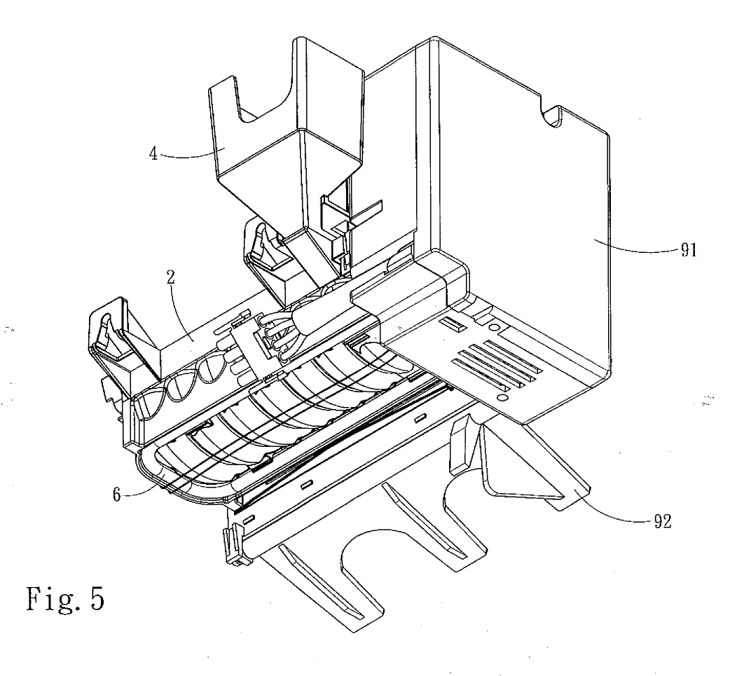

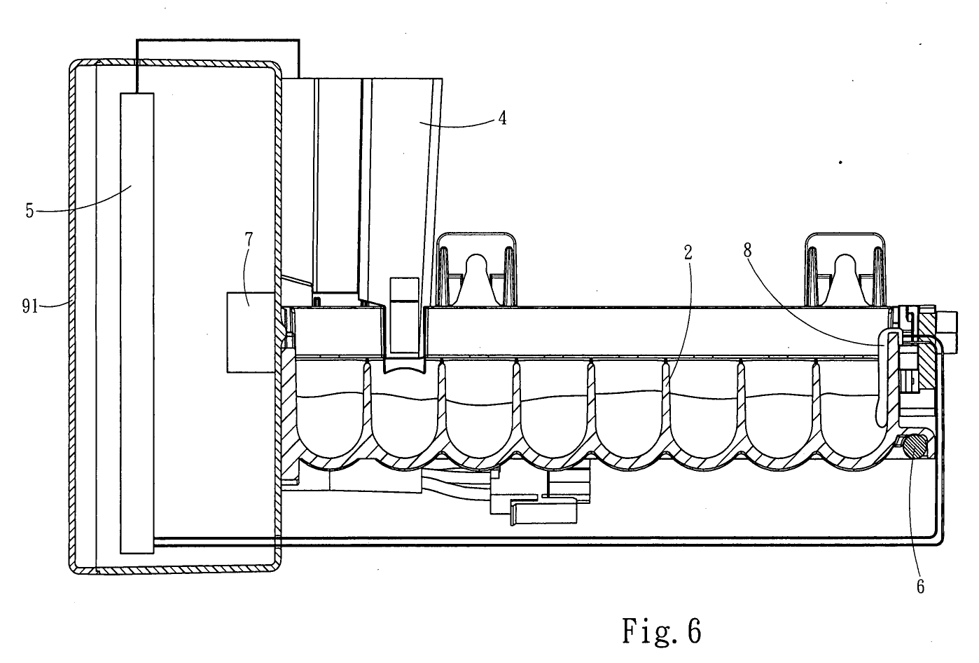

Please refer to FIG. 3 to FIG. 6, which show the ice machine utilizing the method described above. The ice machine includes an ice tray 2, a water inflow mechanism 4 for supplying water into the ice tray 2, an ice sweeping mechanism 3 for removing the ice cubes in the ice tray 2, a heating unit 6 for heating the ice tray 2, a temperature detecting unit 8 mounted on the ice tray 2, and a procedure controlling unit 5. The ice sweeping mechanism 3 is further connected to a driving motor 7 for providing power to remove ice cubes, and the procedure controlling unit 5 and the driving motor 7 are accommodated in a box 91. The ice tray 2 can be connected to a lower guiding board 92 and an upper guiding board 93 for guiding the ice cubes to collection. The temperature detecting unit 8 is located inside the ice tray 2 for detecting the temperature of the ice tray 2. The temperature detecting unit 8 can produce a first signal to the procedure controlling unit 5 when the ice tray temperature reaches the first temperature, so that the procedure controlling unit 5 can correspondingly produce an ice sweeping signal to initiate the ice sweeping mechanism 3. Thereby, the ice removing procedure in the ice making schedule is initiated. When the ice tray 2 becomes empty, the procedure controlling unit 5 will produce a water inflow signal to the water inflow mechanism 4 for supplying water into the ice tray 2. The water inflow mechanism 4 further includes a water storage tank 41 in want of preparing for ice making. Then, the temperature detecting unit 8 detects if the ice tray temperature reaches the third temperature for inferring if the water level in the ice tray 2 reaches the position of the temperature detecting unit 8. The temperature detecting unit 8 is preset to have a temperature deviation, so as to obtain the third temperature by adding the temperature deviation to the ice tray temperature detected as the water inflow procedure 142 starts. If the temperature detecting unit 8 detects that the temperature of the ice tray 2 reaches the third temperature, which means it judges that the water level in the ice tray reaches the position of the temperature detecting unit 8 (for example, suppose that the temperature deviation is +2° C., if the temperature detecting unit 8 detects that the temperature of the ice tray 2 suddenly rises 2° C., it namely decides that the water level has reached the position of the temperature detecting unit 8, as shown in FIG. 6), then a third signal will be produced to the procedure controlling unit 5. After the procedure controlling unit 5 receives the third signal, a water inflow stop signal is transmitted to the water inflow mechanism 4 is for stopping water supplying. Then, when the temperature detecting unit 8 detects that the ice tray temperature reaches the second temperature, it will decide that the water in the ice tray 2 has become frozen, so that the temperature detecting unit 8 will produce a second signal to the procedure controlling unit 5. After the procedure controlling unit 5 receives the second signal, a heating signal is produced to the heating unit 6 for heating the ice tray 2, so as to rise the temperature of the ice tray 2 up to the first temperature. Thereby, the ice making steps are repeated.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for controlling ice machine through temperature setting, comprising steps of:
A. setting a first temperature and a second temperature;
B. continuously detecting the temperature inside an ice tray in the ice machine;
C. starting an ice making schedule as the ice tray temperature is identical to the first temperature, and continuously detecting the ice tray temperature; and
D. heating the ice tray as the ice tray temperature reaches the second temperature for rising the ice tray temperature up to the first temperature, so as to repeat steps B to D for continuing ice making.

2. The method as claimed in claim 1, wherein the first temperature is higher than the second temperature, and the second temperature is lower than the freezing point of water.

3. The method as claimed in claim 1, wherein an ice machine for implementing the method comprises the ice tray, a water inflow mechanism for supplying water into the ice tray, an ice sweeping mechanism for removing ice cubes in the ice tray, a heating unit for heating the ice tray, a temperature detecting unit mounted on the ice tray, and a procedure controlling unit, wherein when the temperature detecting unit detects that the ice tray temperature reaches the first temperature or the second temperature, it produces a first signal or a second signal, and when the procedure controlling unit receives the first signal, an ice sweeping signal is produced to drive the ice sweeping mechanism and a water inflow signal is produced to initiate water supplying, and when the procedure controlling unit receives the second signal, a heating signal is produced to initiate the heating unit for heating the ice tray.

4. The method as claimed in claim 1, wherein ice making schedule sequentially comprises an ice sweeping procedure, a water inflow procedure, and a freezing procedure.

5. The method as claimed in claim 4, wherein between step C and step D, a step of setting a third temperature is further comprised, wherein the third temperature is a water temperature different from the first temperature and when the ice tray temperature reaches the third temperature during the water inflow procedure, the water inflow procedure is stopped and the freezing procedure continues.

6. The method as claimed in claim 5, wherein an ice machine for implementing the method comprises the ice tray, a water inflow mechanism for supplying water into the ice tray, an ice sweeping mechanism for removing ice cubes in the ice tray, a heating unit for heating the ice tray, a temperature detecting unit mounted on the ice tray, and a procedure controlling unit, wherein when the temperature detecting unit detects the ice tray temperature reaches the first temperature or the second temperature, it produces a first signal or a second signal, and when the procedure controlling unit receives the first signal, an ice sweeping signal is produced to drive the ice sweeping mechanism and a water inflow signal is produced to initiate water supply, and when the procedure controlling unit receives the second signal, a heating signal is produced to initiate the heating unit for heating the ice tray.

7. The method as claimed in claim 6, wherein the temperature detecting unit is set to have the third temperature, and when the temperature detecting unit detects that the ice tray temperature reaches the third temperature, a third signal is produced to the procedure controlling unit, so that the procedure controlling unit produces a water inflow stop signal to the water inflow mechanism.

8. The method as claimed in claim 7, wherein the temperature detecting unit is set to have a temperature deviation, so as to obtain the third temperature by adding the temperature deviation to the ice tray temperature detected as the water inflow procedure starts.
